(19) United States
(12) Patent Application Publication
(10) Pub. No.: US 2013/0297389 A1
(43) Pub. Date: Nov. 7, 2013

(54) Conditional, exclusive revenue-sharing method

(71) Applicant: David P. Goldsmith, Harmony, RI (US)

(72) Inventor: David P. Goldsmith, Harmony, RI (US)

(21) Appl. No.: 13/887,285

(22) Filed: May 4, 2013

Related U.S. Application Data
(60) Provisional application No. 61/643,250, filed on May 5, 2012.

(51) Int. Cl. G06Q 30/02

(52) U.S. Cl. CPC G06Q 30/0214
USPC 705/14.16

(57) ABSTRACT

A method is disclosed for hosting a website selling products or services over the Internet and paying a commission to a member who causes those products or services to be listed for sale. Users must be registered as members if they wish to make a purchase from the website. Each member is able to recruit a seller of a product or service to list their product or service for sale on the website. When such products are then sold, the recommending member receives a commission. The website only lists recommended products or services. When payment for a purchase is received, the recommending member is delivered a commission. The recommending member earns an additional commission if the recommending member performs other tasks. The commission may terminate after a period of time unless the recommending member makes a minimum purchase of one or more products or services listed on the website.

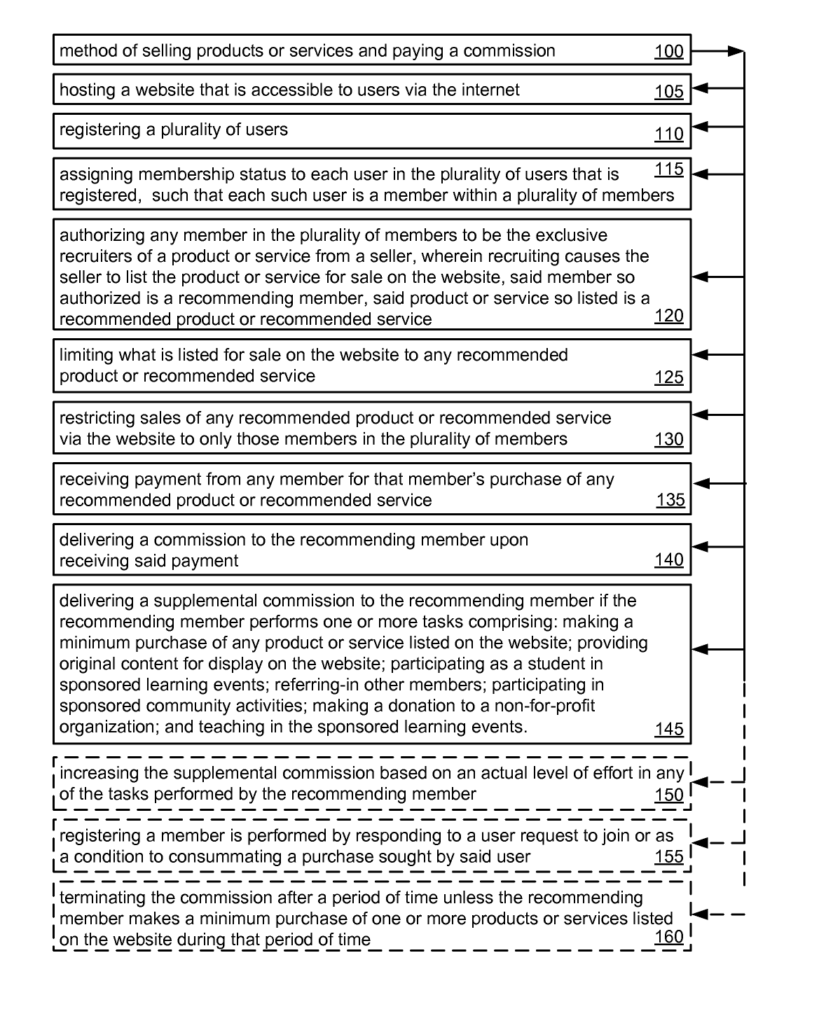

### CROSS-REFERENCE TO RELATED APPLICATIONS

This application claims the benefit of U.S. Provisional Application No. 61/643,250 filed 5 May 2012, which is hereby incorporated by reference herein.

### TECHNICAL FIELD

In the field data processing of financial data and business practices, a method is disclosed relating to supply and demand aggregation in computerized, electronic shopping and further relating to exclusivity in conditional allocation of revenues from the sale of goods and services.

### BACKGROUND ART

The Internet and the World Wide Web has revolutionized retail commerce and created new opportunities for engaging individuals in marketing and promoting the sale of their goods and/or services. With traditional marketing models, individuals are typically hired by a business to market a particular product or service manufactured or sold by the business. Salesmen typically earn a base salary plus a commission for what is sold. The individual salesman will then earn income from their personal promotional efforts. In such arrangements, there are many sales people marketing one or more products of that business.

One barrier encountered by individuals desiring to promote a particular line of goods or services is that there are few easy means to gain a commission on promotional activities without entering a formal agreement between the individual and the retailer. One successful method at engaging a mass of individuals in promoting a particular retail product was invented by AMAZON.COM, which involved “associates” who themselves have websites, and who may link to a AMAZON.COM's web site using a link created by AMAZON.COM to identify the associate. Once a purchaser, having arrived at the AMAZON.COM's website from the link on the associate's web site, makes a purchase, then a small referral commission is allocated to that person. In this arrangement, there are many, perhaps thousands of, potential referring “associates” engaged in advertising for AMAZON.COM products. Each such associate may earn a commission on any sale to a buyer that arrived at AMAZON.COM through the link on the associate's web site. The AMAZON.COM method limits the commission to only those products sold to a person arriving at the AMAZON.COM's website from the associate's web site. So, both the merchant and the associate must have a website. Additionally, associates without a website to publish the link, cannot gain a commission. A method is needed for persons not having their own web site. In order to maximize commissions to individuals, a method is further needed to organize merchants so that essentially one person who sponsors that merchant can earn multiple commissions.

### SUMMARY OF INVENTION

A method is disclosed for hosting a website selling products or services over the Internet and paying a commission to a member who causes those products or services to be listed for sale. The website is accessible to users via the internet. Users must be registered as members if they wish to make a purchase from the website. Each member is able to recruit a seller of a product or service to list their product or service for sale on the website. When such products are then sold via the website, the recommending member receives a commission. The website only lists recommended products or services and only members can buy those products or services listed on the website. When payment is received through the website for purchases made, the recommending member is delivered a commission. The recommending member earns an additional commission if the recommending member performs one or more tasks including making a minimum purchase of any product or service listed on the website; making a donation to a non-for-profit organization; providing original content for display on the website; participating as a student in sponsored learning events; participating in sponsored community activities; and teaching in the sponsored learning events. This additional commission may be graduated so that it increases to reflect an increasing level of effort in any task actually performed by the recommending member. Users become members by asking to join or as a required step in the process of making a purchase on the website. The commission may be made to terminate after a period of time unless the recommending member makes a minimum purchase of one or more products or services listed on the website.

### Technical Problem

With traditional sales models, affiliate marketing and network marketing, all individuals enrolled to market a particular product or service can earn income from their personal promotional efforts. In other words, there can be one product but many sales people marketing that product. There is presently no retail online membership organization that enables a member to earn a sole commission on an item sold when that member causes the seller of that item to list the item for sale on the retail online organization's website.

Presently, there is no organized method available to many individuals that enables any one of these individuals to secure a commission for cumulative sales of a product or service on a website when that one individual has no contractual relationship with the provider of the product or service.

Presently there is no organized method that integrates retailing, education, community service and social networking.

### Solution to Problem

The basic idea captured by the methodology of the present invention is best illustrated by an analogy. Suppose that every store in a local “brick and mortar” shopping mall had only products being sold that were present due to customers' recommendations to store managers. Every product on every shelf and every store would be there after being recommended by another customer. Naturally, everyone would recommend products they already use and love. But the best part is that every time a customer purchases a product or service, the original referring customer earns commission income.

The method disclosed herein implements a method that organizes many individuals into a business that permits any one of these many individuals to receive a commission on the cumulative sales revenue for a particular product or service recommended by that individual for sale on the business website. In this sense, the commission for any product or service is exclusive to the recommending member.

By awarding additional commission to a member for engaging in sponsored activities, the method integrates retailing, education, community service and social networking.

### Advantageous Effects of Invention

The method promotes the sale of goods and services in a business in which for each product or service sold, there is one member or sales person receiving a commission whether there is one sale or many sales of that product or service. The method further integrates retailing, education, community service and social networking.

The method is analogous to a local major shopping mall having products for sale in every aisle and in every store that are there because of customers' recommendations to store managers. To be truly analogous, every product on every shelf and every store would be there after being recommended by another customer. Because every time a customer purchases a product or service, the original referring member earns exclusive commission income, people are expected to recommend products they already use and love. The virtual mall created by implementation of the method is expected to grow to be a very large global marketplace because it has exactly what members want to buy and sell. And because the e-tailing business created by implementation of the method is based on members “earning” from each sale of a product or service they recommended, the members actually earn money every time any member purchases “their” recommended product or service.

Earning is a novel process designed to produce revenue for individual members. While revenue-sharing is not new and there are a variety of established compensation models, what is novel about “earning” with this method is the connection between a single individual and the cumulative sales revenue for a particular product or service.

With earning, there is one product and one sales person: the recommending member. Each recommending member recruits a provider, also known as a producer, of products and/or services and then earns credit (calculated as a base commission income) from purchases of these products and/or services by the entire body of members. Also, each Member/Earner can enhance their base commission percentage by engaging in a number of company-sponsored activities.

### BRIEF DESCRIPTION OF DRAWINGS

The drawing is a diagram of steps in preferred embodiments of the method disclosed herein.

DESCRIPTION OF EMBODIMENTS

In the following description, reference is made to the accompanying drawing, which forms a part hereof and which illustrates the steps of several preferred embodiments of the present invention. The drawing and the preferred embodiments of the invention are presented with the understanding that the present invention is susceptible of alteration and, therefore, other embodiments may be utilized and operational changes may be made, without departing from the scope of the present invention. For example, the steps in the method of the invention may be performed in any order, with or without the optional steps, which are indicated by dashed line boxes and arrows. Required steps are indicated by solid line boxes and arrows.

The first box (100) at the top of the drawing identifies a preferred embodiment of the invention as method of selling products or services and paying a commission. The method encompasses a retail business or company selling products and services.

The second box (105) from the top of the drawing lists a step of hosting a website that is accessible to users via the internet. The website is an online business or virtual store that is involved in retailing products for manufacturers or other sellers of products and/or services. It is a virtual store because it is online and because, preferably, products or services that are purchased are shipped to the member by a provider. Preferably, the business does not purchase or inventory any merchandise.

The third box (110) from the top of the drawing lists a step of registering a plurality of users. It is preferable that anyone may join as a member without charge. Terms and conditions may be specified to provide specificity to the benefits due and responsibilities owed to the member.

Membership creates an account preferably stored on non-transitory memory in a server computer that hosts the website. For example, a benefit to membership may be an entitlement provided to a new member to an amount equal to 5% of all purchases by the new member, within a 30-day period subsequent to their first purchase. This amount preferably would be placed in the new member's cash account to be available for purchases from the website for the following 90-day period. Another example of a benefit would be a rebate offered to a member after the member rates a product or service they purchased on the website. For instance, the member could instantly be awarded a rebate up to 5% of their purchase, which would be deposited in their cash account and available for future purchases. The account may contain information that enables a member to track their purchases, returns, refunds, wish list, gift registry and more.

The fourth box (115) from the top of the drawing lists a step of assigning membership status to each user in the plurality of users that is registered, such that each such user is a member within a plurality of members.

The fifth box (120) from the top of the drawing lists a step of authorizing any member in the plurality of members to be the exclusive recruiters of a product or service from a seller, wherein recruiting causes the seller to list the product or service for sale on the website, said member so authorized is a recommending member, said product or service so listed is a recommended product or recommended service.

### Example—Registration through Listing

In this example, a member or “Earner” first registers or enrolls in the business “Earning Program” accessed on the website for free, agreeing to the terms and conditions. In this example, the Earner then participates in a training program before contacting prospective providers of products and services. A Product Provider for this example is the original manufacturer or marketer and not a distributor, importer or retailer. A Service Provider for this example is any company that sells an experience, its expertise or time. Therefore, in this example, restaurants and product retailers do not qualify. Once the Earner passes the training, he then accesses the website functionality to record the companies, products and services he would like to refer-in. If no other Earner is already working with the prospective Provider (or the specific products of a Provider) and if the information on the Provider or product that is entered by the Earner meets all the requirements, then the Earner is authorized to contact the Provider. In this example, it is necessary for an Earner to identify the specific products they would like to refer-in from a Product Provider. However, it is not necessary for an Earner to identify the specific service packages of a Service Provider. The Earner then contacts the Provider and invites them to receive a coded page link so that the database system on the server hosting the website can record that the Earner has successfully made contact with the prospective Provider. If the Provider enrolls (for free), the Provider can then begin filling out the information on the products or services that the Earner has referred-in. If a Product Provider has other products they would like to sell on the website, the products must first be referred-in by a Member. In this example, a Service Provider may sell any service package on the website.

Preferably, products and services sold through the website are searchable by name, category, location of origin (country, state and region), member rating, and many other parameters. Descriptions of products and services are also preferably populated from the information and images provided by the recruited seller, also known as a referred-in provider. Each list of a product or service may include the name of the recommending member, also described as an earner who referred-in the product or service, with a link to the recommending member's optional blog on the product or service.

Preferably, membership would enable members to connect with each other online and face-to-face. The business hosting the website would preferably give members a variety of ways to get connected, not just to friend, but also to other members and companies, worldwide.

### Example—Members Connected

In this example, members register or enroll to obtain a member's personal account page. The personal account page enables the enrolling member to create a personal profile that may include photos, interests, brief descriptions and links to their referred-in products and services, personal blog, and much more. Members have the option of maintaining a blog for each of the products or services they have caused to be listed on the website.

The method is preferably implemented when providers set their own selling prices for their products and services on the website. The business operating the website would preferably pay providers 60% of their listed retail or actual selling price, keeping the 40% for business operations. Providers should be empowered to directly modify the descriptions and images for their products and services at any time on the website. Providers should be required by agreement with the website business to maintain the inventory levels for their products or services listed on the website. Providers would preferably be given the right to limit the number of products or services that may be available for purchase at any time through the website. The server hosting the website preferably maintains detailed sales history for each provider so that a provider would be authorized to view in their account page and the details of sales made through the website.

The sixth box (125) from the top of the drawing lists a step of limiting what is listed for sale on the website to any recommended product or recommended service. This means that the website lists and sells only products or services that are recommended by a member. In other words, the website does not sell products or services that are not recommended by a member. The website is an Internet-based retailing environment where all of the products and services are referred-in by members.

### Example—Product Providers

In this example, a policy is set for product providers to help ensure that the website is primarily populated with small and emerging product providers. The recommending members or earners are expected to follow a specific sequence by which earners shall refer-in providers and their product SKUs (Stock-Keeping Units; i.e., a number or code used to identify each unique product or item for sale). In this example, product providers are whole companies and the whole company may not be listed, but rather only the individual referred-in products the product providers manufacture may be listed. In this example, the first providers contacted and referred-in by an earner must have fewer than 50 employees. Once a set number of SKUs from Providers in the under-50-employee category have been successfully referred-in by an Earner, the Earner may list and make presentations to prospective Providers with fewer than 100 employees. Once a set number of SKUs from Providers in the under-100-employee category have been successfully referred-in by an earner, the earner may list and make presentations to prospective providers who have fewer than 200 employees. Once a set number of SKUs from providers in the under-200-employee category have been successfully referred-in by an earner, the earner may list and make presentations to prospective providers which have fewer than 500 employees.

It is preferable that a recruiting member may, at any time, relinquish his rights to commissions from sales of a specific product or service, or choose to have it provided by a different provider. For example, a recruiting member might choose to do this if they have reached a maximum number of allowed referred-in providers or for any other reason. Once a referred-in product has been relinquished, the recruiting member may seek to replace the product. For example, at any time, a recruiting member may choose to sell or trade his rights to a referred-in product or provider. Such trading or sale preferably takes place within the website functionality.

The seventh box (130) from the top of the drawing lists a step of restricting sales of any recommended product or recommended service via the website to only those members in the plurality of members.

The eighth box (135) from the top of the drawing lists a step of receiving payment from any member for that member's purchase of any recommended product or recommended service. Preferably, members would be able to pay for their purchases with a credit card, debit card, other payment process, or their cash account in the business operating the website. For this embodiment, a member's cash account would be funded by commissions deposited as a result of sales of recommended products or services to other members.

Preferably, when a product is shipped, the recruited seller, also referred to as a product provider, enters the shipping information in their account page on the server hosting the website in order to receive payment. This is best implemented such that when services are purchased, part A of a voucher code is sent to the service provider and part B of a voucher code is sent to the purchasing member. When the service provider fulfills (or is ready to fulfill) the service the member gives the Part B code to the service provider. The service provider can then enter the Part B code in their account to receive payment for the service. It is also preferable that members may add products and services to their wish list or to a gift registry. Additionally, a purchasing member may enter ratings of products and services sold to that member.

The ninth box (140) from the top of the drawing lists a step of delivering a commission to the recommending member upon receiving said payment.

The tenth box (145) from the top of the drawing lists a step of delivering a supplemental commission to the recommending member if the recommending member performs one or more tasks comprising: making a minimum purchase of any product or service listed on the website; providing original content for display on the website; participating as a student in sponsored learning events; participating in sponsored community activities; making a donation to a non-for-profit organization; and teaching in the sponsored learning events. The opportunity to receive a supplemental commission is a means to incentivize the member to expand the scope and goodwill of the website business.

Sponsored learning events, or simply sponsored learning, is a program of online and face-to-face learning opportunities for members. Learning opportunities are designed to accelerate personal growth and development and may include courses or workshops to: learn or improve skills; broaden knowledge; improve health and well being. Teaching in sponsored learning events is also possible. Teaching would preferably be requested by a service provider or a member who wanted to teach a course as part of a sponsored learning event. To gain approval, the teacher applicant would preferably submit a course plan and credentials in a learning course offering form. It is expected that a course and a teacher would be accepted and authorized when the course promoted the mission of the business hosting the website, or promoted additional membership. It is also expected that some courses would be selected for earner credit, enabling earners to boost their commission by enrolling and successfully completing the course.

Referring in other members is a process that facilitates Earners referring-in individuals to become Members. Earners may earn a bonus commission by referring in people to join as a member. Preferably, this would be implemented by the presence on the member's personal account page of a linkable button. The button would open up a form which contains a code that is specific to the individual member. The form would enable the member to email a link to individuals that he would like to invite to become a member in the website. When the invited individual clicks the link, it confirms interest. Preferably, the referring member earns credit upon the invited person's first purchase.

Engaging in community activity is a charitable process based on a presumption that the more we give, the more we receive. And because giving of a member's time, talents and money may also be important to the business hosting the website, such community activity or charitable donation is fully integrated with earning a supplemental commission. The concept is that the more a member gives each month in time or money to a sponsored community activity, the more credits they earn towards their monthly income. This may be implemented with a requirement to participate in such giving every 4 months equal to a percentage of a member's commissions. If so, then it would be necessary to track hours and any dollars donated.

The eleventh box (150) from the top of the drawing lists an optional step of increasing the supplemental commission based on an actual level of effort in any task performed by the recommending member.

### Example—Earners Earn Income

In this example, after registration, enrollment in an earning program to receive commissions is optional. A member does not have to be a recommending member. The earning program is available to members, but registration only requires agreement with all website terms and conditions.

As soon as a recommending member's referred-in product or service is available for purchase on the website, the recommending member can begin accruing income credits (bonus commissions). Recommending members earn a set Base Commission on all sales from the website of their referred-in products and services. In this example, when 10,000 people purchase the Earner's referred-in product or service, the Earner earns commission on all sales of a referred-in product or service via the website. Also, when an Earner's referred-in products and services have sales of $60,000 in a given month and if the Base Commission rate is 6%, then the recommending member will earn $3,600.

In this example, the same recommending member can increase their Base Commission by up to 10%, by reaching targeted milestones. This percentage may vary in other examples. This bonus commission, also referred to as a supplemental commission, is available during a pre-determined sales period (one month but may be varied to a series of months). In this example, the accrual of the bonus commission is based on each member's monthly achievements, including; volume of purchases from the website; the monthly level of participation in referring-in other members; the monthly level of participation in sponsored learning; the monthly level of participation in sponsored giving; and the monthly level of participation in sponsored teaching.

In this example, each recommending member must buy a minimum of $25 in products or services through the website each month to maintain their commissions. In this example, when an Earner who has commissions due has failed to make the minimum purchases, then $25 is deducted from their commissions and held in their cash account for future purchases only.

In this example, there is a bonus commission payable to the member for recruiting other members, also known as referred-in members, within a 30-day period. In other examples this defined period may be set to 90 days or at any period deemed reasonable. In this example, the actual bonus commission for referring-in 1-3 members boosts the Base Commission by 0.5%; for referring-in 4-11 members boosts the Base Commission by 1.50%; for referring-in 12 or more members boosts the Base Commission by 2.00%.

In this example, the actual bonus commission for purchases on the website by the member are earnable when the purchases are between: $26-$149 during the commissionable month, which boosts the Base Commission by 0.25%; $150-$500 in purchases during the commissionable month, which boosts Base Commission by 0.75%; and $500 or more in purchases during the commissionable month, which boosts the Base Commission by 1.00%.

In this example, the actual bonus commission for sponsored learning (enrolling and completing approved learning programs by the member during a 90-day period) include: One (1) course completed during the previous 90-days boosts the Base Commission by 0.25%; Two to three (2-3) courses completed during the previous 90-days boost the Base Commission by 0.75%; and four or more (4+) courses completed during the previous 90-days boost the Base Commission by 1.00%.

In this example, when a member recruits producers of products and services to sell a product or service on the website, the member is building and maintaining their personal portfolio. Products and services in each personal portfolio grow in value as their website sales volume increases. A personal portfolio is the property of the recommending member, i.e. an earner, as long as the earner maintains his membership and abides by the terms of agreement. Earners are encouraged to periodically refer-in new products and services, or replace slow moving products and services, to their personal portfolio to ensure sustainable value and credits. Each Earner has the option of transferring his personal portfolio to another member based on mutually agreeable terms, but subject to a transfer fee by the business operating the website. Because a member's personal portfolio can have significant and long-term value, it becomes part of each Earner's estate, which is transferable upon the death of the Earner.

The twelfth box (155) from the top of the drawing explains that optionally registering a member is performed by responding to a user request to join or as a condition to consummating a purchase sought by the user.

The thirteenth box (160) from the top of the drawing lists an optional step of terminating the commission after a period of time unless the recommending member makes a minimum purchase of one or more products or services listed on the website during that period of time. Thus, the commission paid to the recommending member may be ended if the recommending member does not make a minimum purchase within for example 30 days. This condition would incentivize members to make purchases.

### Example—Limits on Commissions

In this example, recommending members, i.e. earners, are paid their commissions due within 30 days of the close of a payment period. Amounts due are deposited in an earner's cash account. These amounts, referred to as earner's cash, can be used for purchases on the website, including products, services and sponsored learning courses. The earner's cash may also be used for donations as part of sponsored giving. The earner's cash may be transferred into the earner's non-company account in actual legal currency.

In this example, a charitable mission for the business setting up the website is to enable millions of people to have a sustainable income while freeing up their time to be well and do good. The company mission, therefore, is not to produce millionaires. With a potential 10% commission paid, it is very possible that an Earner could produce commissions over $100,000 each month; even though the average for Earners is expected to be considerably less. To help launch startup companies and fund initiatives globally, in this example, a cap is placed on the amount an Earner can earn annually. This cap is set at $180,000.

In this example, upon paying $180,000 in commissions to an Earner during a 12-month period, the remaining commissionable amounts are put into the Earner's giving account. In other examples, other periods of time may be specified. Amounts in the giving account may be disbursed at the Earner's discretion to any of the following: company sponsored not-for-profit organizations, sponsored startup companies, and sponsored lending in exchange for interest paid into the Earner's account, and other sponsored socially-beneficial opportunities.

### Example—Member Roles

If the website is thought of as a business or company and the website considered a company store, then the members of the company may perform six different roles. Firstly, as a Member/Customer, the member purchases products and/or service in the company store. Secondly, as a Member/Marketer, the member refers providers of products and/or services to sell in the company store and earns exclusive or semi-exclusive base commissions on all sales of referred products and/or services. It is semi-exclusive, because the member may lose the base commission in some embodiments when the member does not undertake to perform certain responsibilities, such as a minimum monthly purchase amount. Thirdly, as a Member/Content Provider, the member may provide original content for the website and can earn credits to expand their base percentage commission. Fourthly, as a Member/Student, the member may participate in company-sponsored learning opportunities and can earn credits to expand their base percentage commission. Fifthly, as a Member/Teacher, the member may provide company-sponsored learning opportunities for other members and can earn credits to expand their base percentage commission. And finally, as a Member/Community Worker, the member may participate in company-sponsored community activities and can earn credits to expand their base percentage commission.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the retail sales industry.

What is claimed is:

1. A method of selling products or services and paying a commission, the method comprising the steps of:
hosting a website that is accessible to users via the internet;
registering a plurality of users;
assigning membership status to each user in the plurality of users that is registered, such that each such user is a member within a plurality of members;
authorizing any member in the plurality of members to be the exclusive recruiters of a product or service from a seller, wherein recruiting causes the seller to list the product or service for sale on the website, said member so authorized is a recommending member, said product or service so listed is a recommended product or recommended service;
limiting what is listed for sale on the website to any recommended product or recommended service;
restricting sales of any recommended product or recommended service via the website to only those members in the plurality of members;
receiving payment from any member for that member's purchase of any recommended product or recommended service;
delivering a commission to the recommending member upon receiving said payment; and
delivering a supplemental commission to the recommending member if the recommending member performs one or more tasks comprising:
making a minimum purchase of any product or service listed on the website;
providing original content for display on the website;
participating as a student in sponsored learning events;
referring-in other members;
participating in sponsored community activities;
making a donation to a non-for-profit organization; and
teaching in the sponsored learning events.

2. The method of claim 1, further comprising the step of increasing the supplemental commission based on an actual level of effort in any of the tasks performed by the recommending member.

3. The method of claim 1, wherein registering a member is performed by responding to a user request to join or as a condition to consummating a purchase sought by said user.

4. The method of claim 1, further comprising the step of terminating the commission after a period of time unless the recommending member makes a minimum purchase of one or more products or services listed on the website during that period of time.
